(19) United States
(12) Patent Application Publication
(10) Pub. No.: US 2004/0114778 A1
(43) Pub. Date: Jun. 17, 2004

(54) Miniature directional microphone

(76) Inventors: Garth W. Gobeli, Albuquerque, NM (US); Joseph Douglas Mather, Albuquerque, NM (US)

Correspondence Address: DeWitt M. Morgan, P.O. Box 1888, Albuquerque, NM, 87103-1888, US

(21) Appl. No.: 10/317,926

(22) Filed: Dec. 11, 2002

(51) Int. Cl. H04R 25/00; H04R 9/08; H04R 11/04; H04R 17/02; H04R 19/04; H04R 21/02

(52) U.S. Cl. 381/356; 381/160; 381/174

(57) ABSTRACT

A capacitance microphone including: (1) an electrically conductive element that includes a surface which, when placed at (at least approximately) the focal point of a parabolic surface, receives sound energy reflected from the parabolic surface at a plurality of angles which are substantially perpendicular to the surface at the point of impingement; (2) an electrically conductive stalk for supporting the electronically conductive element; (3) a layer of piezoelectric material coating the surface; (4) a layer of insulating material covering a substantial portion of the stalk, but not covering the surface; and (5) a layer of conducting material covering the piezoelectric material and a substantial portion of the insulating material. Preferably, the surface approximates a spherical or hemispherical surface, the center of which is at the focal point of the parabolic like surface. The invention also includes a microphone assembly incorporating a parabolic surface and the above described capacitance microphone.

### CROSS REFERENCE TO RELATED APPLICATION

This application is a continuation-in-part of provisional application 60/346,940 filed Jan. 10, 2002.

### FIELD OF THE INVENTION

This invention relates generally to microphones and particularly to a novel spherically shaped capacitance microphone and to the utilization thereof for the fabrication of miniature directional microphone assemblies.

### PRIOR ART

A conventional directional microphone assembly 10, illustrated in FIG. 1a, is fabricated by using a small capacitance microphone 12 placed at the focal position of a large parabolic reflector 14. The capacitance microphone, 12, illustrated in FIG. 1b, is comprised of a thin metallic diaphragm 16 stretched over a rim 18 and spaced very close to the inner surface 19 of the microphone cavity 20. The diaphragm vibrates when sound energy impinges on it and the resultant variation of capacitance produces an electrical signal. This construction results in a high quality microphone. The focal length of the parabola 14 is significantly larger that the parabola's open input face so that the sound energy reaching the microphone, indicated by the dashed lines 22, is incident on the microphone 12 at angles close to the normal of the surface of diaphragm 16. Since such microphones are some 10s of millimeters in diameter, the parabola face is some 100s of millimeters in diameter, thus producing a large microphone assembly 10. These directional microphones concentrate received sound onto the capacitance microphone by a factor of about 100 (i.e., the concentration factor). The concentration factor is the area of the parabolic reflector divided by the area of the capacitance microphone.

If the size of the parabola's input face were to be increased as shown in FIG. 2, in an effort to improve the sensitivity of the directional microphone, by hypothetically extending the size of the parabola, as indicated at 26, the sound incident near the edge of the parabola 14 indicated by dashed lines 28 would impinge onto the planar microphone 12 at large angles relative to the normal to the surface of diaphragm 16, which would result in a significant deterioration of performance due to overfilling of the microphone. Also, sound energy received at large off axis angles by a planar surface microphone would be preferentially reflected rather than being absorbed by the microphone diaphragm, so that increases in sensitivity are small while acceptable sound reproduction is diminished.

U.S. Pat. Nos. 3,881,056, 3,895,188, and 4,037,052 describe parabolic reflectors that have capacitance microphones placed at or near the parabola's focal point. In all cases the microphones are planar capacitance types of the type described above. The parabolas in all cases are of the order of 10 or more inches in diameter.

U.S. Pat. Nos. 2,017,122 and 6,408,080 both describe directional microphones having two reflecting surfaces that concentrate the received sound energy onto a planar capacitance microphone.

U.S. Pat. No. 1,732,722 demonstrates an early version of a parabolic reflector that focuses sound onto a planar capacitance microphone.

In all of the above referenced patents, a large parabolic reflector is employed to focus sound onto a capacitance microphone that is flat and planar in shape.

U.S. Pat. No. 6,243,474 B1 describes a miniature planar microphone and unified array of such microphones fabricated by micro-machining techniques. Again the microphone is of the planar capacitance type.

U.S. Pat. No. 6,148,089 describes a directional microphone that is of the class of cardiod or hyper-cardiod microphones, as is shown in the polar pattern response of the microphone (See FIG. 8 and FIG. 10 of this patent). This type of directionality depends on a difference in response to sound directed to the front and back surfaces of a microphone. Directionality is achieved by the differential pressure received by planar microphone surfaces due to off axis sound.

### OBJECT OF THIS INVENTION

It is the object of this invention to provide for a spherically shaped capacitance microphone and a method for fabricating such a microphone.

It is further the object of this invention to incorporate such a spherical microphone with a parabolic reflector to form a directional microphone assembly of exceptional sensitivity that also has a very sharp angular response characteristic.

It is a further to object of this invention to provide for a spherical microphone/parabolic reflector combination that can be fabricated into a miniaturized directional microphone assemblies.

It is further the object of this invention to provide for a small directional microphone that has readily changeable fabrication properties, so that it can be modified to meet requirements for many different deployment requirements.

It is further the object of this invention to provide a microphone assembly which has a concentration factor in excess of 2800.

It is further the object of this invention to provide for a miniature directional microphone that can be utilized in large scale arrays of such microphones.

These and other objects will be evident from the disclosure set forth herein.

### SUMMARY OF THE INVENTION

A capacitance microphone including: (1) an electrically conductive element that includes a surface which, when placed at (at least approximately) the focal point of a parabolic like surface, receives sound energy reflected from the parabolic like surface at a plurality of angles which are substantially perpendicular to the surface at the point of impingement; (2) an electrically conductive stalk for supporting the electronically conductive element, at least a portion of the stalk defining a first electrical contact for the microphone; (3) a layer of piezoelectric material coating the surface; (4) a layer of insulating material covering a substantial portion of the stalk, but not covering the surface; and (5) a layer of conducting material covering the piezoelectric material and a substantial portion of the insulating material. Preferably, the surface of the electrically conductive element approximates a spherical or hemispherical surface, the center of which is at the focal point of the parabolic like surface. However, surfaces of other configurations (e.g., multi-faceted) will work, so long as such a surface receives sound energy reflected from the parabolic like surface at a plurality of angles which are substantially perpendicular to such surface. The layers of piezoelectric material, insulating material and conducting material are all thin films, preferably multiple thin films. The piezoelectric material may be lead ziconate/lead titanate (PZT).

The invention also includes a microphone assembly incorporating a parabolic like surface and the above described capacitance microphone. The parabolic like surface may be a parabola and the surface of the electrically conductive element a sphere. The ratio of the diameter of the surface of the electrically conductive element is approximately 0.001 times the diameter of the parabolic surface, so that a directional microphone of exceptionally sharp forward angular response is formed. Further, the surface of the electrically conductive element may have a diameter of approximately 0.005 millimeters and the parabolic surface may have a diameter of approximately 3.0 millimeters, so that a directional microphone of very small dimensions is produced. The electrically conductive element may be potted with said parabolic like surface. The electrically conductive element is, typically, within the volume defined by the parabolic like surface.

### BRIEF DESCRIPTION OF THE DRAWINGS

FIG. 1a (prior art) shows a parabolic reflector combined with a capacitance microphone to form a directional microphone according to prior art.

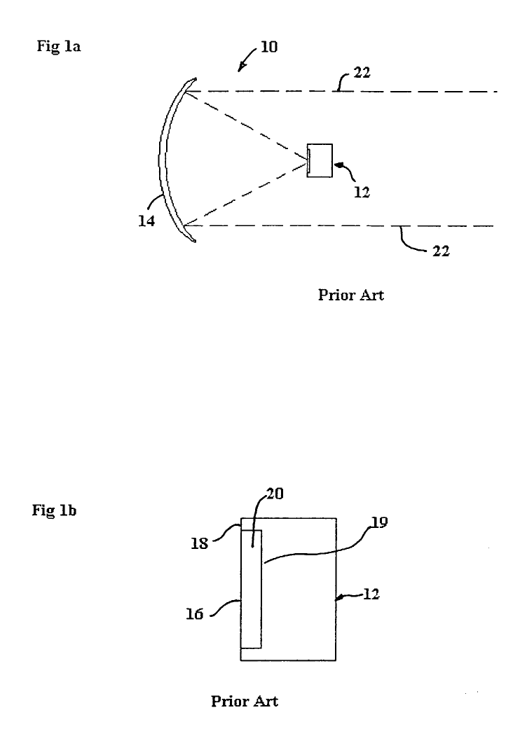

FIG. 1b (prior art) shows the geometry of a planar capacitance microphone according to the prior art.

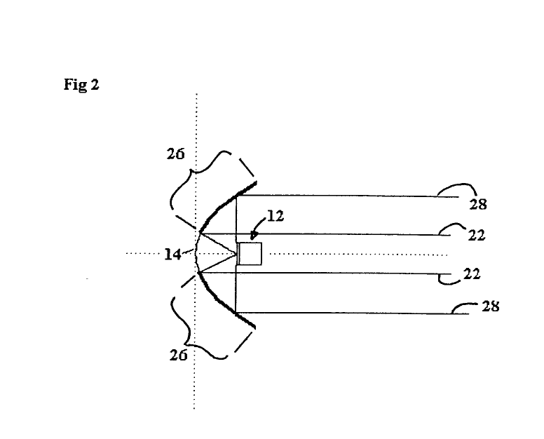

FIG. 2 shows the hypothetical extension to a parabolic reflector and how it affects the incidence of sound energy onto the capacitance microphone.

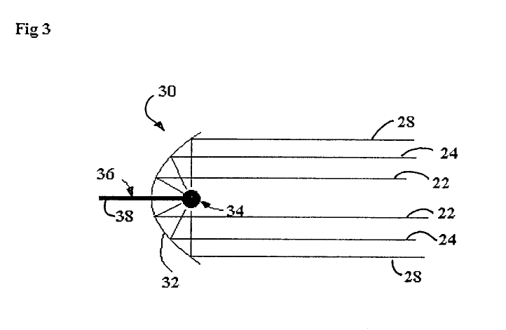

FIG. 3 shows how the spherical microphone of the present invention is employed with a short focal length parabolic reflector.

FIG. 4 diagrams the details of employing the spherical microphone of the present invention with the extended parabolic reflector of the type shown in FIG. 2.

FIGS. 5a through 5d show the manufacturing steps employed to fabricate a spherical capacitance microphone according to the present invention.

FIG. 6 shows a suggested modification of the spherical microphone illustrated in FIGS. 5a-5d.

FIG. 7 illustrates the use of the modified spherical microphone of FIG. 6 with a short focal length parabolic reflector.

FIGS. 8a and 8b show the encapsulation of the parabolic reflector/spherical microphone of the present invention.

FIG. 9 illustrates the angular characteristics for the three different reflector/microphone geometries given in Table 1.

### DESCRIPTION OF THE PREFERRED EMBODIMENTS

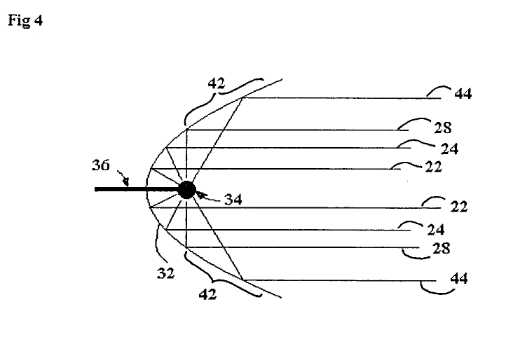

Our innovation replaces the planar capacitance microphone element of prior art with a spherically shaped microphone, as shown in FIG. 3. Microphone assembly 30 includes a small deep parabola 32 which concentrates the sound energy onto a spherically shaped microphone 34 which is supported by a stalk 36. Such a spherically shaped microphone will receive all sound energy from a deep parabola at an angle that is locally perpendicular to the microphone surface as shown by the arrowed lines 22, 24, and 28. Thus, for example, a spherical microphone placed a distance of 10 millimeters from the apex 38 of parabola 32 having a focal length of 10 millimeters and a diameter of 40 millimeters will receive sound energy reflected by the parabolic reflector at angles up to 90 degrees relative to the parabola's axis as shown by the arrows 28 in FIG. 3. As demonstrated below, when a spherical microphone of diameter 0.04 mm is employed with a 40 mm diameter parabola, these dimensions give a concentration factor of 280,000 to 1. This extremely large concentration factor results in the very sensitive detection limit for such a system as well as providing a sharp directional feature of the device.

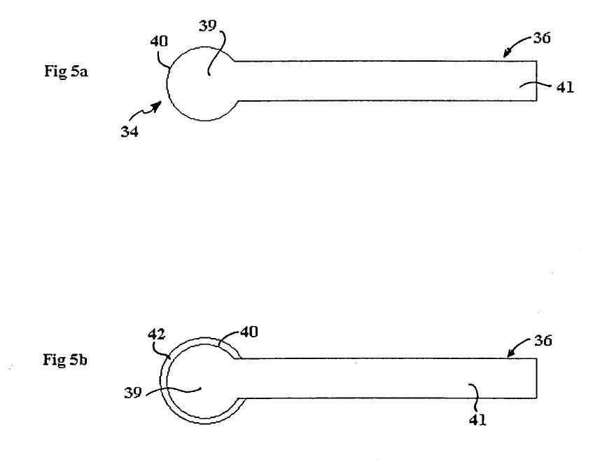

FIG. 4 shows the situation if the parabola is extended even further, by adding the area 42. In this case the peripheral sound rays 44 reach the spherical microphone detector at angles substantially larger than 90 degrees, but remain locally normal to the spherical surface of microphone 34. This additional parabolic area adds substantially to the detector sensitivity, since the additional added area of the parabola is an annular region that increases the parabola's surface area substantially. In addition to providing an efficient detection for such focused sound, the combination results in a directional microphone of greatly enhanced directionality features as shown in calculations presented below.

The small spherically shaped capacitance microphone of the present invention may be formed by depositing a film 42 of piezoelectric material, for example of PZT (lead zirconate titanate), onto a spherical metallic surface 40. This film is then covered by a thin layer of a conductor, such as vacuum evaporation of gold or platinum. The two metallic elements form the two plates of a spherically shaped capacitor as discussed below.

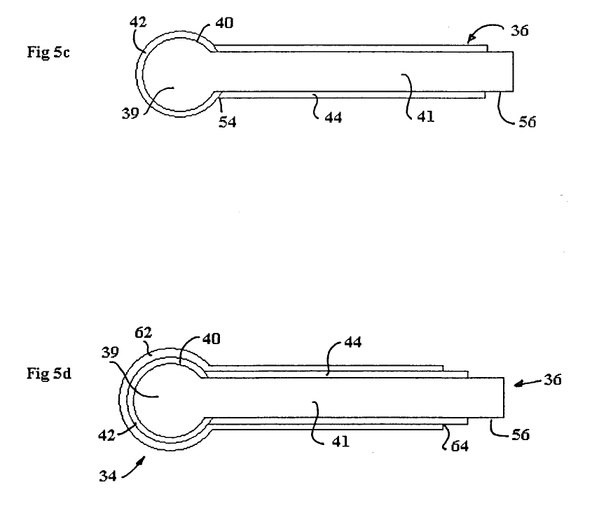

A metallic substrate 39 has a spherically shaped surface 40, as shown in FIG. 5a. The substrate forming the spherical surface is supported by the core 41 of stalk 36. The metal comprising these structures may be platinum, but another conductive material may be substituted. Additionally the spherical or hemispherical surface 40 can be formed from other metals. The spherical surface can be formed by grinding/polishing techniques or by electroetching/electropolishing methods. One additional method can be that of melting the stalk core 41 briefly in an oxy-acetylene flame, quickly removing the molten end of the stalk core and permitting the liquid surface tension to form into a smooth ball as it re-solidifies. This method has been employed to form smooth balls on the end of platinum wires.

The next step in forming the spherical microphone structure is shown in FIG. 5b. The spherical surface 40 of FIG. 5b is coated with a thin film of a piezoelectric material 42. While the material initially employed here will be PZT, other piezoelectric substances may also be utilized. PZT is a well-known and very sensitive piezoelectric material that is frequently employed for the very sensitive detection of acoustic sounds. (It is the material of choice employed by the navy for its sonar hydrophones.) This piezoelectric material is an amorphous mixture of lead zirconate and lead titanate and, thus, has no crystalline structure that would negate its efficient use in a spherical configuration. The PZT is deposited onto the spherical surface 40 by the well-known sol-gel method of deposition of thin films of PZT from organo-metallic precursor solutions. See M. Kazanari, et al., Jpn. J. Appl Phys., Vol. 39, Part 1, No. 9b, pp. 5421-5425, September 2000, and “Effects of thickness of the piezoelectric and dielectric properties of lead zirconate titanate thin films, L. Lian and N. R. Sottos, Journal of Applied Physics, Vol. 87, No. 8, pp. 3941-3949 (2000). This procedure has been shown to produce thin films having piezoelectric properties that are close to those of bulk material. It provides very uniform thin films of PZT which are of high quality. Each deposition cycle results in a PZT film of approximately 0.1 to 0.2 micrometers (2×10⁻⁷ meters) in thickness. Thicker films are formed by repeating the deposition cycle to achieve a film of the desired thickness. However, thicknesses greater than a few micrometers usually result in films having an accumulation of some physical defects that degrade their piezoelectric properties. Films of about 1 micrometer thickness may be utilized, although films of lesser or greater thickness could be employed. PZT films of 1 to 2 micrometers posses a dielectric constant of about 400, which is less than that of bulk material, but which renders very good piezoelectric performance.

It is in principle possible to form this layer of PZT by machining and etching of bulk material. This method will be difficult. However, the superior piezoelectric properties of bulk PZT might make this modification appropriate for some applications, especially those requiring large spherical microphones.

In principal, a spherical capacitor of any dimension can be formed by this method. However, for many applications small spherical microphones are desired. Such microphones can be utilized with parabolic reflectors of small sizes so that useful microphone assemblies of a few millimeters that employ spherical microphones of diameters down to a few hundredths of a millimeter in dimension can be formed.

The next step in the formation of the spherical microphone element is shown in FIG. 5c. A dielectric coating 44 is applied to the core 41 of support stalk 36. This dielectric film can be from sputtering or by vacuum deposition of a suitable insulating material such as silica. Also, a dielectric film can be provided by coating the desired areas with a polyimide material that can be applied by brush. This insulating layer slightly overlays the PZT thin film as shown at 54 in FIGS. 5c. Also the dielectric layer is limited along core 41, so that a portion of metallic core 41 such as the end 56 is exposed at a distance from the spherical surface 40. Other insulating materials can be employed for this purpose and the possibility of deposition from liquid solutions is also possible.

Finally, a thin metallic overcoat 62 is applied to the entire exposed spherical surface of the PZT film 42 and most of the dielectric coating 44, so that this metallic coating terminates along coating 44 such that the core 41 itself remains insulated from this metallic overcoat, as indicated in FIG. 5d at the position indicated as 64. This metallic overcoat may be vacuum evaporated or sputtered gold of a thickness of 1000 angstroms (10⁻⁷ meters) or thicker. Again, other metals deposited by other methods would be acceptable in this usage.

When the metallic core 41 of stalk 36 forms one electrical connection and the thin conductive film layer 62 forms a second electric connection, a very high quality and sensitive capacitance microphone is formed.

This spherical microphone 34 is placed carefully at the focus of a parabolic reflector cavity 32 as shown in FIG. 3 and the entire assembly forms a highly sensitive and extremely directional miniature microphone assembly 30.

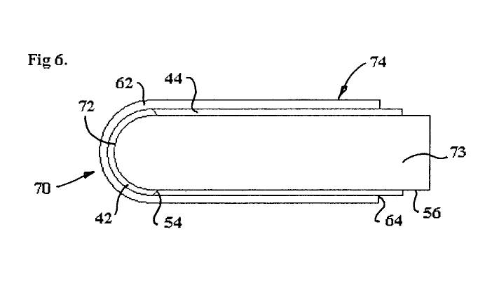

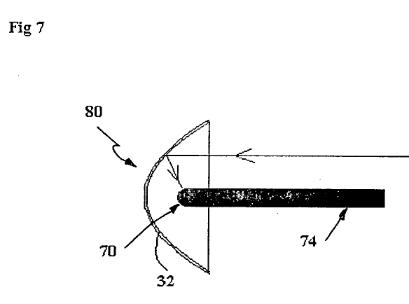

FIG. 6 shows a modified microphone 70 in which the ball shaped end 40 of the stalk 36 is replaced by a hemispherically shaped end 72 of a larger core 73 of stalk 74. In such a configuration the stalk 74 is placed in a position distal to the parabolic reflector surface 32 so that sound energy is focused onto the hemispherical surface 72. The assembly is identified as 80 in FIG. 7. The PZT coating 42, dielectric coating 44, overlap 54 and metallic overcoat 62 are the same as set forth in the previous example.

One example of the dimensions for this microphone assembly 30 are as follows: A parabolic cavity of 40 millimeters diameter with a focal length of 10 millimeters. and a spherical microphone assembly of 0.04 millimeters in diameter. This configuration will be employed as a “baseline” design. Such a device is very sensitive and would provide an extreme directionality of 1.1 degrees full width at half maximum (FWHM) which could have important usage as a directional underwater sonar hydrophone. Additional examples of military usage would be for directional detection of sniper or artillery fire.

A second dimensional example would be of a parabolic diameter of 3.0 millimeters with a focal length of 0.75 millimeters that employs a spherical microphone element of 0.040 millimeters in diameter. Such a combination provides an extremely compact unit (⅛ inch in diameter) with modest directionality (an acceptance angle for incoming sound of 22 degrees full width at half maximum (FWHM), which would be very advantageous for applications as a directional hearing aid.

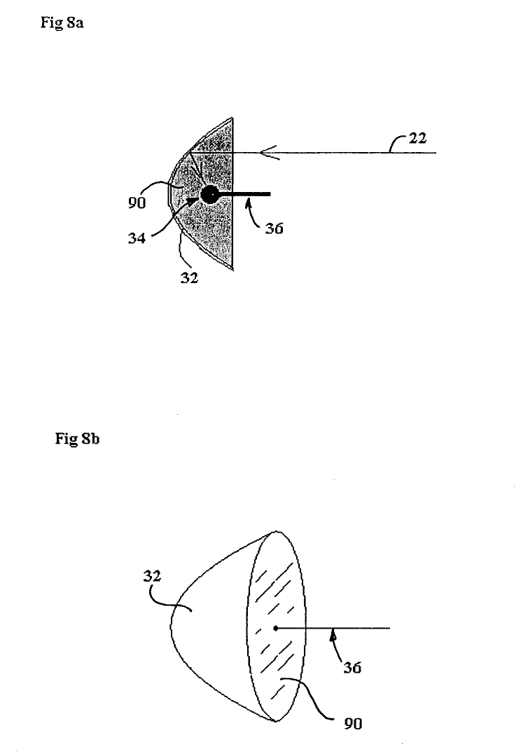

An additional variation of the above described directional microphones is to encapsulate the structure with a suitable encapsulant 90 shown in FIGS. 8a and 8b, to shield it from environmental problems and to ruggedize it against mechanical problems. A typical hard curing epoxy or any other suitable material can be employed as the encapsulant. The acoustic properties of the microphone system would be only slightly modified from the non-encapsulated microphone and the directional and detectivity properties would not be impacted.

The combination of a parabolic reflector that has a spherical shaped microphone at its focal point provides a geometry that permits straightforward calculation of the directional performance of the device. Otherwise reflectors of other configurations, such as ellipticalor others could be employed. Also, a microphone of shape other than spherical, such as conical or multi-faceted, would be acceptable as a receiving unit.

Calculated Directional Microphone Angular Relative Response

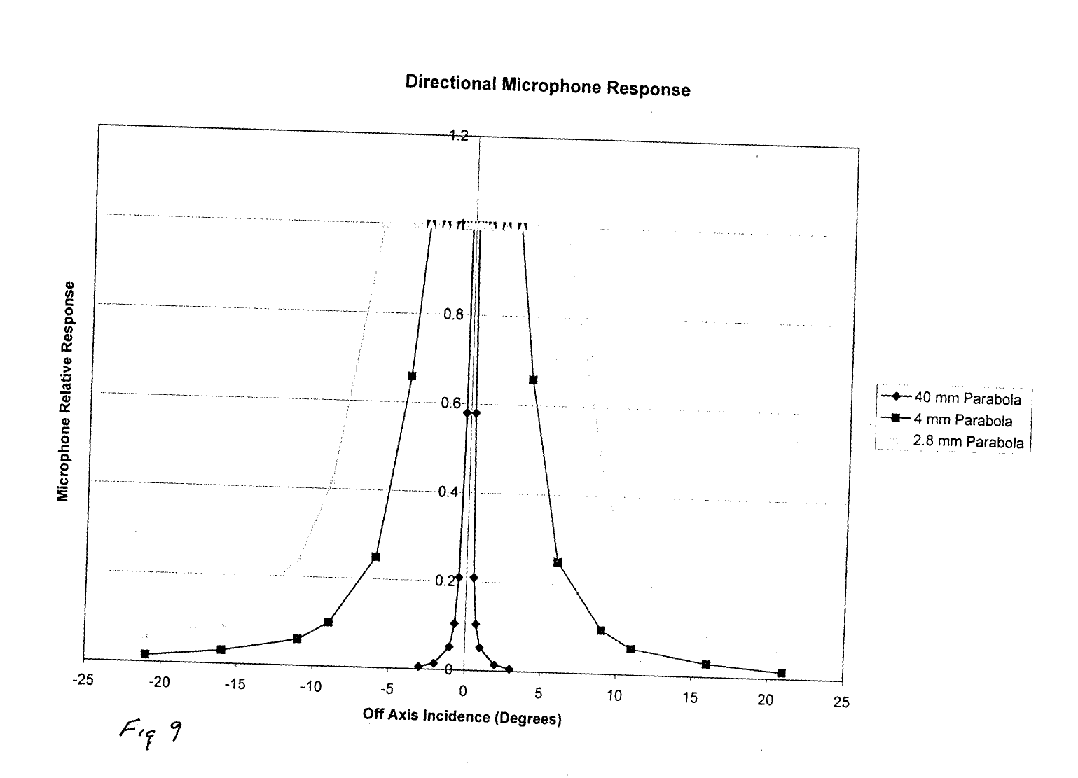

We have calculated the directional response properties of spherical microphones of 0.04 mm diameter that are employed with parabolas of 40 mm, 4 mm, and 2.8 mm. The results of the calculations are presented in Table 1 and illustrated in FIG. 9.

TABLE 1
Response relative to on-axis detectivity for a spherical microphone of
0.04 mm diameter when employed with the indicated parabola.
PRC is Parabolic Reflector Cavity.

| Degrees off | | | |
|---|---|---|---|
| axis | 40 mm PRC dia. | 4.0 mm PRC dia. | 2.8 mm PRC dia. |
| 0.2 | 1.0 | 1.0 | 1.0 |
| 0.3 | .58 | 1.0 | 1.0 |
| 0.5 | .21 | 1.0 | 1.0 |
| 0.7 | .106 | 1.0 | 1.0 |
| 1.0 | .053 | 1.0 | 1.0 |
| 2.0 | .014 | 1.0 | 1.0 |
| 3.0 | .0058 | 1.0 | 1.0 |
| 4.0 | .001 | .66 | 1.0 |
| 6.0 | 0.0 | .25 | 1.0 |
| 9.0 | 0.0 | .10 | .42 |
| 11.0 | 0.0 | .06 | .24 |
| 16.0 | 0.0 | .03 | .09 |
| 21.0 | 0.0 | .015 | .06 |

Estimation of the Sensitivity of the New Directional Microphone

The minimum sound wave pressure of frequency 1000 Hz that can be detected by the human ear is 2×10⁻⁵ Pa, where atmospheric pressure is 10⁺⁵ Pa. Thus, a pressure wave of 2×10⁻⁵ Pa=2×10⁻⁵ N/m² is barely audible to the acute human ear and is designated as the 0 db point of the acoustic scale. We shall estimate the response for a 2×10⁻³ Pa incident acoustic signal. For a 3 mm diameter parabola with a 0.04 mm diameter spherical detector, we find the concentration factor to be

A1=πR₁²=1.06×10⁻⁵ m²=the planar area of the parabola input face.

A2=2πR₂²=5×10⁻⁹ m²=the surface area of the 0.04 mm diameter hemispherical microphone.

Thus, for a 3-mm diameter parabola input aperture that is focused onto a 40-micron (0.04 mm) microphone the concentration factor is A1/A2=2.2×10⁺³.

Thus, the pressure P incident on the spherical microphone surface will be:

P=(2×10⁻³)×(2.2×10⁺³)=8.8 N/m².

The conversion efficiency of PZT is 70×10⁻¹² coulombs per N (Newton). So, we find Q₀ (the charge per unit area developed by PZT) to be:

Q₀=(70×10⁻¹²)×(8.8)=6.2×10⁻¹⁰ coulombs/m².

For the 40 micron diameter hemispherical PZT microphone element, the area is A2=2.5×10⁻⁹ m² and the charge is thus Q=1.6×10⁻¹⁸ coulombs.

PZT functions as a capacitor having a dielectric constant κ=400. Thus, we have:

C=κκ₀A/d=(400)×(8.85×10⁻¹²)×(2.5×10⁻⁹)/(1×10⁻⁶)=8.9×10⁻¹² farads, where:

C=capacitance in farads

κ=dielectric constant of PZT=400

κ₀=permitivity of free space=8.85×10⁻¹² farads/meter

A=area of the capacitor=A2=2.5×10⁻⁹ m²

d=spacing of the electrodes=thickness of the PZT film=1.0 microns=1×10⁻⁶ meters.

Now we note that CV=Q where:

C=capacitance of the microphone in farads

V=voltage developed by the capacitance microphone in volts; and

Q=the charge on the capacitance microphone.

We have V=Q/C=(1.6×10⁻¹⁸)/(1.8×10⁻¹¹)=2.0×10⁻⁷ v=0.20 μv

This represents a signal level for the device that is about the level of noise for straightforward high quality audio amplifier/preamplifier electronics having a bandwidth of 300-3000 Hz and capacitance values near 10⁻¹¹ coulombs. Employing more sophisticated electronics probably would not yield a substantial improvement in signal-to-noise response.

By changing the thickness of the PZT film, for example to 2 microns (2×10⁻⁶ meters), the output voltage of the capacitance microphone will be increased to 0.80 μV.

One major and very significant property of this type of directional microphone assembly is that the response to the device to acoustic sounds reaching the microphone assembly from any direction outside the indicated response envelope is essentially zero. This is due to the concentration factor of 2800 for the small parabolas and 280,000 for the large parabolas utilized in the calculations of Table 1 and illustrated in FIG. 9 when a 0.040 diameter receiving spherical microphone is used. Thus, sound reaching the detector from all other directions is effectively attenuated by that concentration factor. This results in a microphone assembly that truly has zero backside response. Thus, the electronic gain can be increased enormously to amplify sound received in the forward direction while background noise from all other angles is ignored. This fact indicates that a remarkable improvement in directional hearing aids is possible. Also, a similar improvement in underwater hydrophones is possible for the appropriately configured directional microphone assembly.

Whereas the drawings and accompanying description have shown and described the preferred embodiment of the present invention, it should be apparent to those skilled in the art that various changes may be made in the form of the invention without affecting the scope thereof.

We claim:

1. A capacitance microphone comprising:
a. an electrically conductive element which includes a surface which, when placed at the focal point of a parabolic like surface, receives sound energy reflected from said parabolic like surface at a plurality of angles which are locally substantially perpendicular to said surface;
b. an electrically conductive stalk for supporting said element, at least a portion of said stalk defining a first electrical contact for said microphone;
c. a layer of piezoelectric material coating said surface;
d. a layer of insulating material covering a substantial portion of said stalk, but not covering said surface; and
e. a layer of conducting material covering said piezoelectric material and a substantial portion of said insulating material.

2. The capacitance microphone of claim 1, wherein said surface approximates a hemispherical surface.

3. The capacitance microphone of claim 1, wherein said surface approximates a spherical surface.

4. The capacitance microphone of claim 1, wherein said surface approximates a multifaceted surface.

5. The capacitance microphone of claim 1, wherein said layers of piezoelectric material, insulating material and conducting material are all thin films.

6. The capacitance microphone of claim 5, wherein each of said layers constitutes multiple thin films.

7. The capacitance microphone of claim 1, wherein said piezoelectric material is PZT.

8. A microphone assembly comprising:
a. a parabolic like surface;
b. an electrically conductive element which includes a surface which is placed at the focal point of said parabolic like surface to receive sound energy reflected from said parabolic like surface at a plurality of angles which are locally substantially perpendicular to said surface;
c. an electrically conductive stalk for supporting said element, at least a portion of said stalk defining a first electrical contact for said microphone;
d. a layer of piezoelectric material coating said surface;
e. a layer of insulating material covering a substantial portion of said stalk, but not covering said surface; and
f. a layer of conducting material covering said piezoelectric material and a substantial portion of said insulating material.

9. The microphone assembly of claim 8, wherein said surface approximates a hemispherical surface.

10. The microphone assembly of claim 8, wherein said surface approximates a spherical surface.

11. The microphone assembly of claim 8, wherein said surface approximates a multifaceted surface.

12. The microphone assembly of claim 8, wherein the ratio of the area of the parabolic like surface to the area of said surface of said electrically conductive element is equal to or greater than 2500.

13. The microphone assembly of claim 12, wherein said parabolic like surface is parabolic and said surface of said electrically conductive element is spherical.

14. The microphone assembly of claim 13 in which the ratio of the diameter of said surface of said electrically conductive element is approximately 0.001 times the diameter of said parabolic surface, so that a directional microphone of exceptionally sharp forward angular response is formed.

15. The microphone assembly of claim 14 in which said surface of said electrically conductive element has a diameter of approximately 0.005 millimeters and said parabolic surface has a diameter of approximately 3.0 millimeters, so that a directional microphone of very small dimensions is produced.

16. The microphone assembly of claim 8, wherein said electrically conductive element is potted with said parabolic like surface.

17. The microphone assembly of claim 16, wherein said electrically conductive element is potted within said parabolic like surface.

18. The microphone assembly of claim 8, wherein said electrically conductive element is within the volume defined by said parabolic like surface.
